(19) United States
(12) Patent Application Publication
(10) Pub. No.: US 2025/0307055 A1
(43) Pub. Date: Oct. 2, 2025

(54) GROUPING AND LOCALIZATING ERRORS IN DISTRIBUTED SYSTEMS

(71) Applicant: International Business Machines Corporation, Armonk, NY (US)

(72) Inventors: Pranita Sharad Dewan, New York, NY (US); RAGHU KIRAN GANTI, White Plains, NY (US); Mudhakar Srivatsa, White Plains, NY (US); Joshua M Rosenkranz, White Plains, NY (US)

(21) Appl. No.: 18/616,436

(22) Filed: Mar. 26, 2024

(51) Int. Cl. G06F 11/07

(52) U.S. Cl. CPC G06F 11/079; G06F 11/0721; G06F 11/0781

(57) ABSTRACT

In an approach for grouping errors in distributed systems, a processor receives a plurality of error records. A processor temporally groups the plurality of error records using a timeseries segmentation technique to create temporal groups of records. A processor further groups each temporal group of records using spatial grouping techniques to create groups of records that are temporally and spatially grouped. A processor ranks the groups of records based on a density of each group of records. A processor selects a top N groups of records with highest densities based on the ranking. A processor localizes an issue causing the plurality of error records based on the top N groups of records and hierarchy levels of the top N groups of records.

### BACKGROUND OF THE INVENTION

The present invention relates generally to the field of data processing, and more particularly to a method and system for grouping and localizing errors in distributed systems.

A distributed computer system consists of multiple software components that are on multiple computers but run as a single system. The computers that are in a distributed system can be physically close together and connected by a local network, or they can be geographically distant and connected by a wide area network. A distributed system can consist of any number of possible configurations, such as mainframes, personal computers, workstations, minicomputers, and so on. The goal of distributed computing is to make such a network work as a single computer. Distributed systems offer many benefits over centralized systems, including scalability and redundancy. Distributed computing systems can run on hardware that is provided by many vendors and can use a variety of standards-based software components. Such systems are independent of the underlying software. They can run on various operating systems and can use various communications protocols.

### SUMMARY

Aspects of an embodiment of the present invention disclose a method, computer program product, and computer system for grouping and localizing errors in distributed systems. One or more processors receive a plurality of error records. One or more processors temporally group the plurality of error records using a timeseries segmentation technique to create temporal groups of records. One or more processors further group each temporal group of records using spatial grouping techniques to create groups of records that are temporally and spatially grouped. One or more processors rank the groups of records based on a density of each group of records. One or more processors select a top N groups of records with highest densities based on the ranking. One or more processors localize an issue causing the plurality of error records based on the top N groups of records and hierarchy levels of the top N groups of records.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a computing environment, for running an error grouping program, in accordance with an embodiment of the present invention.

FIG. 2 is a flowchart depicting operational steps of the error grouping program, for grouping and localizing errors in distributed systems, running on a computer of the computing environment of FIG. 1, in accordance with an embodiment of the present invention.

FIG. 3 is a flowchart illustrating the operational sub-steps for the spatial grouping step of the error grouping program, running on the computer of the computing environment of FIG. 1, in accordance with an embodiment of the present invention.

### DETAILED DESCRIPTION

Embodiments of the present invention recognize that issues in distributed systems, such as those consisting of multiple microservices, often manifest as a deluge of errors. To get an effective understanding of the issue, it is important to be able to determine where the issue originates from, i.e., where the errors are occurring, which requires appropriately grouping the errors because going through thousands of individual errors to understand the problem is not feasible. In addition, the errors often have temporal (i.e., when they occurred) and spatial (i.e., where they occurred) locality that can be leveraged when creating the groups. Thus, the resulting groups have the benefit of providing localization for the corresponding issues. Conventionally, grouping methods first use time windows to provide a temporal grouping of the errors and then correlation and clustering techniques for errors in each time window to group them spatially. These conventional grouping methods might take into account the topology/hierarchy of an application, but generally only simple topologies/hierarchies are supported.

Increasingly, large applications consisting of several microservices use container orchestration platforms. This adds several new dimensions to these applications and to each microservice, i.e., more complicated topologies/hierarchies, in which these new dimensions cannot be fully captured using existing techniques that rely on simple topologies/hierarchies of an application, i.e., cannot be properly grouped and clustered. For instance, a microservice could be running within a particular logical container within a particular pod within a particular node within a particular cluster. In addition, the microservice is also running on a physical machine within a datacenter. In other words, the microservice can be a part of multiple topologies/hierarchies and more sophisticated mechanisms are needed to capture these correctly as part of a grouping and localization method.

Thus, given the errors and multiple hierarchies associated with components in a distributed computing system for running an application, embodiments of the present invention provide a system and method for performing spatial grouping of errors received for the application in an unsupervised manner. Embodiments of the present invention treat hierarchies as a lattice and errors are rolled up along the specified hierarchies while taking into account the entropy and the number of groups at each level. The goal is to ensure that there are no less than a certain number of errors in each group while maximizing the entropy across the groups. Limiting the minimum number of errors per group while maximizing entropy helps to obtain a tractable number of dense groups that are also informative in determining the overarching issue. These groups can be further examined to localize and determine the issue causing the errors, i.e., identifying the root cause of an error to, e.g., one faulty part.

Embodiments of the present invention are flexible enough to accept (i.e., handle) multiple hierarchies in the form of a lattice structure and can provide much better control of the number of groups while also maximizing the information gained from the obtained groups, and therefore, better address the multiple composite hierarchies associated with components in applications running in distributed computing systems. Embodiments of the present invention improve over the current technologies by providing the ability to consider multiple hierarchical dimensions as context for grouping events/alerts in a distributed system.

Embodiments of the present invention temporally group error records (or just “records” as used herein) using time series segmentation techniques, such as regression-based segmentation. For each group created, embodiments of the present invention further group the error records spatially by (1) creating an unmaterialized lattice view based on a number of levels in provided hierarchies and (2) traversing the lattice in a Breadth-First-Search (BFS) while choosing groupings that maximize entropy. Embodiments of the present invention further group together the temporally and spatially grouped error records if associated composite keys of two groups lie in a subtree of some node in the lattice and the divergence between the two groups is less than a specified threshold, generating a final set of groups. Embodiments of the present invention rank the set of groups based on their density since denser groups could provide better information on the issue trying to be determined. Embodiments of the present invention localize an error based on the levels in the hierarchies of the final set of groups.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Implementation of embodiments of the present invention may take a variety of forms, and exemplary implementation details are discussed subsequently with reference to the Figures.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

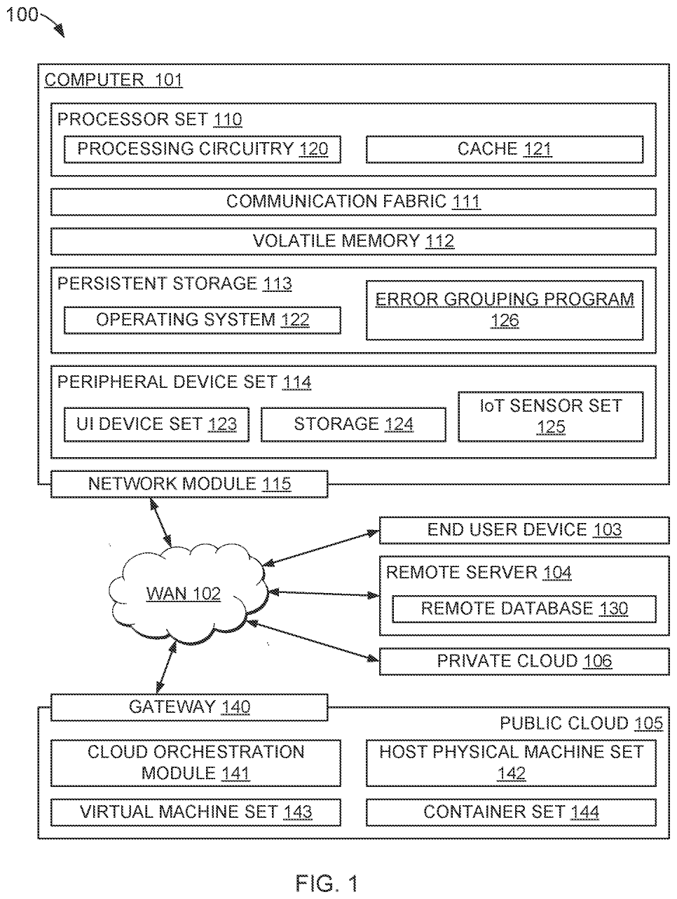

In FIG. 1, computing environment 100 contains an example of an environment for the execution of at least some of the computer code involved in performing the inventive methods, such as error grouping program 126. In addition to error grouping program 126, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and error grouping program 126), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processors set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 116 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

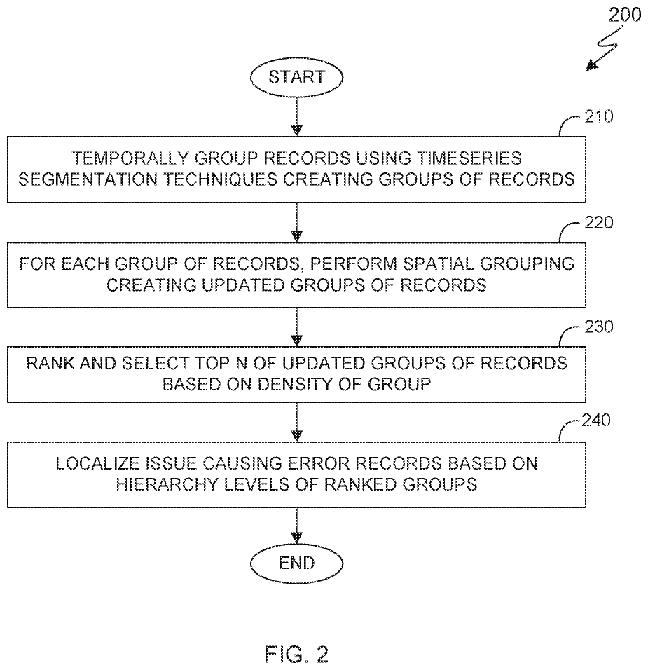

FIG. 2 is a flowchart, generally designated 200, illustrating the operational steps for error grouping program 126, running on computer 101 of computing environment 100 of FIG. 1, in accordance with an embodiment of the present invention. In an embodiment, error grouping program 126 operates to group and localize errors in a distributed system. Hierarchical structures for the multiple hierarchies associated with components of the distributed system are known. It should be appreciated that the process depicted in FIG. 2 illustrates one possible iteration of the process flow, which is initiated upon receiving a set of error records (also referred to as just “records”) for a distributed system and may be repeated for each set of error records received by error grouping program 126. In an embodiment, error grouping program 126 receives a set of error records after a pre-set time period has passed, i.e., periodically. In an embodiment, error grouping program 126 receives a plurality of error records after a pre-set threshold number of errors has occurred in the system. In an embodiment, each error records includes temporal information (i.e., when the error occurred) and spatial information (i.e., where the error occurred and associated hierarchical information).

In step 210, error grouping program 126 temporally groups the plurality of error records using timeseries segmentation techniques, such as regression-based segmentation, to create temporal groups of records. In other words, error grouping program 126 groups the plurality of error records based on when they occurred using the temporal information received with each error record. For example, if normally there is 1 record per second received and suddenly 10 records are received in two seconds then those two seconds and those 10 records form a temporal group of records.

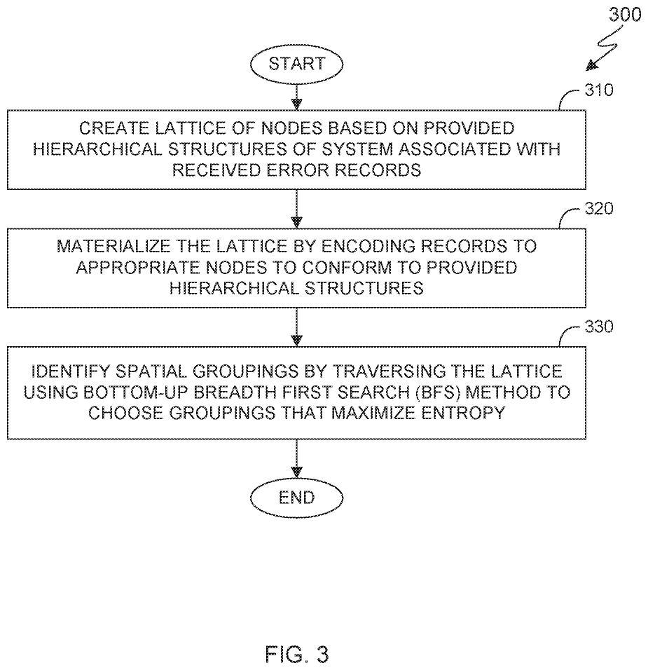

In step 220, error grouping program 126, for each temporal group of records, further groups a respective temporal group of records using spatial grouping techniques to create updated groups of records that are temporally and spatially grouped. In other words, error grouping program 126 further groups (i.e., creates smaller groups) each temporal group of records based on spatial entities included in the spatial information received with each error record (i.e., where the error is occurring) and grouping spatial entities that are topologically related. For example, errors occurring on a node and a network switch connected to that node would be spatially grouped together. The goal of the spatial grouping is for error grouping program 126 to form narrow spatial groups that have the highest density of error records enabling localization of the issue causing the error records. The steps for performing this spatial grouping on each temporal group of records formed in step 210 are further described below with reference to FIG. 3.

In step 230, error grouping program 126 ranks and selects a top N of the updated groups of records based on a density of a group. In an embodiment, error grouping program 126 ranks the updated groups of records based on a density of each group and then selects a top N of the ranked groups to be used in the next step. As used herein, N is a preset number that can be any positive numeral, e.g., a top 5 groups ranked with the 5 highest densities can be selected by error grouping program 126. For this invention, density is the number of error records normalized by the size of the group. For example, if the group for the IP address range 10.0.0.* covering 4 machines that has 8 error records, the density is 8/4=2 errors/machine. In another example, if the group for the IP address range 10.0.* covering 64 machines that has 8 error records, then the density drops to 8/64=0.125, which would be ranked lower than the first example with a density of 2.

In step 240, error grouping program 126 localizes an issue based on the top N ranked groups of records and the levels of hierarchies of those top N ranked groups of records. In other words, localizing an issue means being able to narrow down the root cause of an issue, e.g., identify the location of the issue causing the error records within a distributed system by looking at the hierarchy levels of the top N ranked groups of error records.

FIG. 3 is a flowchart, generally designated 300, illustrating the operational sub-steps for the spatial grouping step of error grouping program 126, running on computer 101 of computing environment 100 of FIG. 1, in accordance with an embodiment of the present invention. In an embodiment, error grouping program 126 performs a further grouping of the temporal groups of records formed in step 210 of FIG. 2 using spatial grouping techniques. It should be appreciated that the process depicted in FIG. 3 illustrates one possible iteration of the process flow, which is performed and repeated for each temporal group of records formed in step 210 of FIG. 2.

In step 310, error grouping program 126 creates an unmaterialized lattice structure of nodes based on provided hierarchical structures (i.e., known structures) of the infrastructure of the distributed system associated with the received error records, i.e., a number of levels in provided hierarchies of the records of the respective temporal group. The provided hierarchies will have a certain set of levels and can be determined from the records themselves of the respective temporal group, e.g., metadata of the records. Each error record includes metadata including spatial information (i.e., where the error occurred) that will provide hierarchy levels for each hierarchical structure associated with that error record. In a Kubernetes example, the hierarchy of the records would be a container level, pod level, and node level hierarchy. In an infrastructure level IP address hierarchy, the hierarchy of the records would be simply defined by the levels in each dimension. For example, an IP address may have 5 levels: 10.0.0.1, 10.0.0.*, 10.0.*, 10.*, and *. In an embodiment, error grouping program 126 creates an unmaterialized lattice structure by identifying the levels in each dimension for the provided hierarchy of the records of the respective temporal group. The lattice structure is unmaterialized because every node in the lattice does not have to be enumerated, e.g., if there are no error records in 10.0.0.*, then there are no error records in 10.0.*, 10.*, etc., thus those nodes do not need to be enumerated. Continuing the IP address example, if a provided hierarchy of the records of the respective temporal group has three dimensions and each dimension has 10 levels, error grouping program 126 creates an unmaterialized lattice view with 10×10×10=1000 nodes in the lattice.

In step 320, error grouping program 126 materializes the lattice by encoding records of the respective temporal group to appropriate nodes to conform to the provided hierarchy levels of the records. In an embodiment, error grouping program 126 encodes or places the appropriate records of the respective temporal group of records into their appropriate node within the lattice creating spatial groups of records at each node in the lattice. For example, if the received records represent IP addresses and geohashes, each node in the lattice represents a specific rollup level for an IP address and the geohash. Thus, if the initial values of IP address and geohash for some error record were 10.0.0.1 and 3r0dz, a node that is two levels up in the IP address hierarchy and one level up in the geohash hierarchy would encode the record as 10.0.* and 3r0d. hierarchical

In step 330, error grouping program 126 identifies spatial groupings by traversing the lattice using bottom-up Breadth First Search (BFS) method that chooses groupings that maximize entropy. In an embodiment, error grouping program 126 determines the updated groups of records (i.e., records grouped temporally and spatially) that are used in step 230 described above. This bottom-up BFS method starts traversing the lattice at the lowest level nodes and looks for close by nodes in the lattice that have a lot of error records (i.e., a preset threshold) and determines if these nodes (i.e., the current node and the close by nodes) can be rolled up into a bigger node group that has a high density, i.e., a higher level node that has many error records. For example, if the dimensions are location and age and there are at least a certain threshold number of records in node (New York, 0-10) and close by node (New York, 10-20), these two nodes are rolled up into node (New York, 0-20). Similarly, if there are at least a certain threshold number of records with node (NY, 10-20), node (New Jersey, 10-20), and multiple other similar nodes (state N, 10-20), these nodes are rolled up into node (USA, 10-20).

In an embodiment, error grouping program 126 traverses the lattice from bottom up by checking if the number of records at a current node exceeds k, a preset threshold number of error records during a certain time window (the certain time window being associated with the respective temporal grouping). If the number of records at the current node does exceed k, then error grouping program 126 marks this current node as a “supremum” or “least upper bound”, i.e., the highest node in the lattice to roll up any lower nodes up into, ensuring that while traversing nodes in the future no nodes higher than this marked node need to be explored because the entropy of nodes higher in the lattice is lower than nodes lower in the lattice. The aim is to end up with the smallest number of groups while maximizing the entropy of the groups. If the number of records in each group at the current node does not exceed k, then error grouping program 126 does not roll up any lower nodes into this current node.

In an embodiment, error grouping program 126 computes the entropy at a node as

$$- log ( \frac{{n}_{1}}{N} ) - log ( \frac{{n}_{2}}{N} ) … - log ( \frac{{n}_{m}}{N} )$$

where n₁, n₂ . . . nₘ are the current group sizes and N=n₁+n₂+ . . . +nₘ, the total number of records. If the entropy is greater than a maximum entropy (e.g., the preset threshold of k), error grouping program 126 identifies the spatial groups as the best grouping so far, i.e., the smallest and most dense set of spatial groups.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more processors, a plurality of error records;
temporally grouping, by the one or more processors, the plurality of error records using a timeseries segmentation technique to create temporal groups of records;
further grouping, by the one or more processors, each temporal group of records using spatial grouping techniques to create groups of records that are temporally and spatially grouped;
ranking, by the one or more processors, the groups of records based on a density of each group of records;
selecting, by the one or more processors, a top N groups of records with highest densities based on the ranking; and
localizing, by the one or more processors, an issue causing the plurality of error records based on the top N groups of records and hierarchy levels of the top N groups of records.

2. The computer-implemented method of claim 1, wherein receiving the plurality of error records comprises receiving temporal and spatial information for each error record of the plurality of error records.

3. The computer-implemented method of claim 1, wherein the timeseries segmentation technique is regression-based segmentation.

4. The computer-implemented method of claim 1, wherein the density of each group of records is a size of the group divided by a number of error records.

5. The computer-implemented method of claim 1, wherein further grouping each temporal group of records using spatial grouping techniques comprises:
creating, by the one or more processors, a lattice of nodes of a respective temporal group of records based on a number of levels in provided hierarchies of error records of the respective temporal group of records; and
identifying, by the one or more processors, the groups of records that are temporally and spatially grouped by materializing and traversing the lattice using bottom-up Breadth First Search (BFS) method that chooses groupings that maximize entropy.

6. The computer-implemented method of claim 5, wherein further grouping each temporal group of records using spatial grouping techniques comprises:
computing, by the one or more processors, the entropy at a node of the lattice as
$$- log ( \frac{{n}_{1}}{N} ) - log ( \frac{{n}_{2}}{N} ) … - log ( \frac{{n}_{m}}{N} )$$
where n₁, n₂ . . . nₘ are current group sizes and N=n₁+n₂+ . . . +nₘ, a total number of records;
determining, by the one or more processors, whether the entropy at the node is greater than a preset entropy threshold.

7. A computer program product comprising:
one or more computer readable storage media and program instructions stored on the one or more computer readable storage media, the program instructions comprising:
program instructions to receive a plurality of error records;
program instructions to temporally group the plurality of error records using a timeseries segmentation technique to create temporal groups of records;
program instructions to further group each temporal group of records using spatial grouping techniques to create groups of records that are temporally and spatially grouped;
program instructions to rank the groups of records based on a density of each group of records;
program instructions to select a top N groups of records with highest densities based on the ranking; and
program instructions to localize an issue causing the plurality of error records based on the top N groups of records and hierarchy levels of the top N groups of records.

8. The computer program product of claim 7, wherein the program instructions to receive the plurality of error records comprise program instructions to receive temporal and spatial information for each error record of the plurality of error records.

9. The computer program product of claim 7, wherein the timeseries segmentation technique is regression-based segmentation.

10. The computer program product of claim 7, wherein the density of each group of records is a size of the group divided by a number of error records.

11. The computer program product of claim 7, wherein the program instructions to further group each temporal group of records using spatial grouping techniques comprise:
program instructions to create a lattice of nodes of a respective temporal group of records based on a number of levels in provided hierarchies of error records of the respective temporal group of records; and
program instructions to identify the groups of records that are temporally and spatially grouped by materializing and traversing the lattice using bottom-up Breadth First Search (BFS) method that chooses groupings that maximize entropy.

12. The computer program product of claim 11, wherein the program instructions to further group each temporal group of records using spatial grouping techniques comprise:
program instructions to compute the entropy at a node of the lattice as
$$- log ( \frac{{n}_{1}}{N} ) - log ( \frac{{n}_{2}}{N} ) … - log ( \frac{{n}_{m}}{N} )$$
where n₁, n₂ . . . nₘ are current group sizes and N=n₁+n₂+ . . . +nₘ, a total number of records;
program instructions to determine whether the entropy at the node is greater than a preset entropy threshold.

13. A computer system comprising:
one or more computer processors;
one or more computer readable storage media;
program instructions collectively stored on the one or more computer readable storage media for execution by at least one of the one or more computer processors, the stored program instructions comprising:
program instructions to receive a plurality of error records;
program instructions to temporally group the plurality of error records using a timeseries segmentation technique to create temporal groups of records;
program instructions to further group each temporal group of records using spatial grouping techniques to create groups of records that are temporally and spatially grouped;
program instructions to rank the groups of records based on a density of each group of records;
program instructions to select a top N groups of records with highest densities based on the ranking; and
program instructions to localize an issue causing the plurality of error records based on the top N groups of records and hierarchy levels of the top N groups of records.

14. The computer system of claim 13, wherein the program instructions to receive the plurality of error records comprise program instructions to receive temporal and spatial information for each error record of the plurality of error records.

15. The computer system of claim 13, wherein the timeseries segmentation technique is regression-based segmentation.

16. The computer system of claim 13, wherein the density of each group of records is a size of the group divided by a number of error records.

17. The computer system of claim 13, wherein the program instructions to further group each temporal group of records using spatial grouping techniques comprise:
program instructions to create a lattice of nodes of a respective temporal group of records based on a number of levels in provided hierarchies of error records of the respective temporal group of records; and
program instructions to identify the groups of records that are temporally and spatially grouped by materializing and traversing the lattice using bottom-up Breadth First Search (BFS) method that chooses groupings that maximize entropy.

18. The computer system of claim 17, wherein the program instructions to further group each temporal group of records using spatial grouping techniques comprise:
program instructions to compute the entropy at a node of the lattice as
$$- log ( \frac{{n}_{1}}{N} ) - log ( \frac{{n}_{2}}{N} ) … - log ( \frac{{n}_{m}}{N} )$$
where n₁, n₂ . . . nₘ are current group sizes and N=n₁+n₂+ . . . +nₘ, a total number of records;
program instructions to determine whether the entropy at the node is greater than a preset entropy threshold.
